(19) United States
(12) Patent Application Publication
(10) Pub. No.: US 2016/0337305 A1
(43) Pub. Date: Nov. 17, 2016

(54) SYSTEM, METHOD, AND APPARATUS FOR PUBLISHING SOCIAL NETWORK POSTS

(71) Applicant: ALIBABA GROUP HOLDING LIMITED, George Town (KY)

(72) Inventors: Shuyan LIU, Hangzhou (CN); Tian ZHANG, Hangzhou (CN)

(73) Assignee: ALIBABA GROUP HOLDING LIMITED

(21) Appl. No.: 15/098,158

(22) Filed: Apr. 13, 2016

(30) Foreign Application Priority Data
May 12, 2015 (CN) 201510239537.8

(51) Int. Cl. H04L 12/58; H04L 29/08; G06F 17/30; H04L 29/06

(52) U.S. Cl. CPC H04L 51/32; H04L 65/403; H04L 67/306; G06F 17/30867; G06F 17/3089

(57) ABSTRACT

A method for publishing social network posts is disclosed. The method may be implemented by a server. The method may comprise storing user preferences of social network posts, receiving a request from a terminal device of a posting user, the request carrying identification information of the posting user related to a draft post including characteristic information, determining a contact list of the posting user and user preferences of users on the contact list, determining from the users on the contact list, target users having user preferences matching the characteristic information, and sending information of the target users to the terminal device.

### CROSS REFERENCE TO RELATED APPLICATION

The present application is based on and claims the benefits of priority to Chinese Application No. 201510239537.8, filed May 12, 2015, the entire contents of which are incorporated herein by reference.

### TECHNICAL FIELD

The present application relates to methods, apparatus, and systems for publishing social network posts.

### BACKGROUND

As Internet technology develops and more people use mobile devices, social networking has become an increasingly important part of people's life. It can affect peoples' ways of acquiring information, thinking, and lives. In the virtual space, users can manage the circles of friends and make the social network a window of acquiring information, showcasing, and marketing.

For example, users can upload photos, publish status, or share articles. Other users can comment on these posts and receive replies, forming an interactive online environment. Sometimes, people may find certain users publish/feed too many photos or articles, which flood the screen and take up a lot of space. If that happens when a person is browsing the social network, the person may have to scroll down many times to skip all the flooding content. For instance, flooding an online social network with marketing photos/texts of a product may prevent viewers from finding valuable content or contents related to the viewers' genuine interests.

### SUMMARY

One aspect of the present disclosure is directed to a method for publishing social network posts. The method may be implemented by a server. The method may comprise storing user preferences of social network posts; receiving a request from a terminal device of a posting user, the request carrying identification information of the posting user related to a draft post including characteristic information; determining a contact list of the posting user and user preferences of users on the contact list, determining from the users on the contact list, target users having user preferences matching the characteristic information; and sending information of the target users to the terminal device.

Another aspect of the present disclosure is directed to a method for publishing social network posts. The method may be implemented by a terminal device. The method may comprise obtaining characteristic information of a draft post of a posting user; sending, to a server, a request to obtain information of target users related to the draft post, the request carrying identification information of the posting user and the characteristic information, the target users being obtained from a contact list of the posting user and having user preferences matching the characteristic information; receiving, from the server, the information of the target users, and presenting, to the posting user, the target users to tag based on the information of the target users.

Another aspect of the present disclosure is directed to a method for publishing social network posts. The method may be implemented by a terminal device of a posting user. The method may comprise storing user preferences of users on the posting user's contact list; obtaining characteristic information of a draft post of the posting user; determining, from the contact list, target users having user preferences matching with characteristic information of the post; and presenting the determined target users to the posting user.

Another aspect of the present disclosure is directed to a method for processing posts. The method may be implemented by a terminal device. The method may comprise determining a location of a posting user using the terminal device to publish a post, and sending an identification of the posting user and the location to a server for the server to determine user preferences of the posting user based on the location and store a corresponding relation between the identification and the user preferences in a database.

Another aspect of the present disclosure is directed to a method for publishing social network posts. The method may be implemented by a server. The method may comprise receiving, from a terminal device, an identification of a posting user and a location of the posting user when the posting user publishes a post; determining user preferences of the posting user based on the location; and generating a database item storing a corresponding relation between the identification and the user preferences.

Another aspect of the present disclosure is directed to a non-transitory computer-readable storage medium storing one or more programs. The one or more programs comprising instructions which, when executed by a computer system including a server for publishing social network posts, cause the computer system to perform a method. The method may comprise storing user preferences obtained from users' social network posts; receiving a request from a terminal device of a posting user to obtain information of users related to a draft post of the terminal device, the request carrying identification information of the posting user drafting the post and characteristic information of the draft post;, determining a contact list of the posting user and user preferences of users on the contact list, determining from the users on the contact list, target users having user preferences matching the characteristic information; and sending information of the target users to the terminal device.

Another aspect of the present disclosure is directed to a non-transitory computer-readable storage medium storing one or more programs. The one or more programs comprising instructions which, when executed by a terminal device for publishing social network posts, cause the terminal device to perform a method. The method may comprise obtaining characteristic information of a draft post of a posting user; sending, to a server, a request to obtain information of target users related to the draft post, the request carrying identification information of the posting user and the characteristic information, the target users being obtained from a contact list of the posting user and having user preferences matching the characteristic information; receiving, from the server, the information of the target users; and presenting, to the posting user, the target users to tag based on the information of the target users.

Another aspect of the present disclosure is directed to a non-transitory computer-readable storage medium storing one or more programs. The one or more programs comprising instructions which, when executed by a terminal device of a posting user for publishing social network posts, cause the terminal device to perform a method. The method may comprise storing user preferences of users on the posting user's contact list, the user preferences being obtained from the users' social network posts; obtaining characteristic information of a draft post of the posting user, determining, from the contact list, target users having user preferences matching with characteristic information of the post; and presenting the determined target users to the posting user.

Another aspect of the present disclosure is directed to a non-transitory computer-readable storage medium storing one or more programs. The one or more programs comprising instructions which, when executed by a terminal device for processing posts, cause the terminal device to perform a method. The method may comprise determining a location of a posting user using the terminal device to publish a post, and sending an identification of the posting user and the location to a server for the server to determine user preferences of the posting user based on the location and store a corresponding relation between the identification and the user preferences in a database.

Another aspect of the present disclosure is directed to a non-transitory computer-readable storage medium storing one or more programs. The one or more programs comprising instructions which, when executed by a computer system including a server for publishing social network posts, cause the computer system to perform a method. The method may comprise receiving, from a terminal device, an identification of a posting user and a location of the posting user when the posting user publishes a post, determining user preferences of the posting user based on the location, and generating a database item storing a corresponding relation between the identification and the user preferences.

Another aspect of the present disclosure is directed to an apparatus for publishing social network posts. The apparatus may comprise a first user preferences storage unit configured to store user preferences obtained from users' social network posts, a request receiving unit configured to receive, from a terminal device, a request to obtain information of users related to a draft post of the terminal device, the request carrying identification information of the posting user drafting the post and characteristic information of the draft post; a user preferences determination unit configured to determine a contact list of the posting user and user preferences of users on the contact list; a target user determination unit configured to determine, from the users on the contact list, target users having user preferences matching the characteristic information; and an information sending unit configured to send information of the target users to the terminal device, such that the terminal device can suggest the target users to the posting user drafting the post and the posting user can select the target users to tag in the post.

Another aspect of the present disclosure is directed to an apparatus for publishing social network posts. The apparatus may comprise a characteristic information collecting unit configured to collect, according to an instruction, characteristic information of a draft post, the instruction indicating that a positing user is drafting a post on the terminal device; a request sending unit configured to send, to a server, a request to obtain information of users related to the draft post, the request carrying identification information of the posting user drafting the post and characteristic information of the draft post, such that the server can determine, based on pre-stored user preferences and from a contact list of the posting user, target users whose user preferences match with the characteristic information and send information of the target users to the terminal device; and a suggestion unit configured to suggest, to the posting user, users to tag based on the information of the target users, so that the target users can be tagged in the post and the server can send notifications of the post to respective terminal devices of the tagged users.

Another aspect of the present disclosure is directed to an apparatus for publishing social network posts. The apparatus may comprise a second user preference storage unit configured to locally store user preferences of users obtained from social network posts published by the users, the users being on a contact list of a positing user using the terminal device; a second characteristic information collecting unit configured to collect, according to an instruction, characteristic information of a draft post, a second target user determination unit configured to determine, from the contact list of the positing user drafting the post, target users whose user preferences match with the characteristic information of the post; and a second suggestion unit configured to suggest the target users to the positing user drafting the post, so that the target users can be tagged in the post through a preset mechanism and the server can send notifications of the post to respective terminal devices of the tagged target users.

Another aspect of the present disclosure is directed to an apparatus for publishing social network posts. The apparatus may comprise a location information determination unit configured to determine a location of a positing user using a terminal device to publish a post, and an uploading unit configured to upload an identification of the positing user and the location to a server, such that the server can determine user preferences of the posting user based on the location and can store a corresponding relation between the identification and the user preferences in a database.

Another aspect of the present disclosure is directed to an apparatus for publishing social network posts. The apparatus may comprise an information receiving unit configured to receive, from a terminal device, an identification of a posting user and a location of the posting user when he/she publishes a post; an information determination unit configured to determine user preferences of the positing user based on the location; and a database item generation unit configured to generate a database item, storing a corresponding relation between the identification and the user preferences.

Additional features and advantages of the present disclosure will be set forth in part in the following detailed description, and in part will be obvious from the description, or may be learned by practice of the present disclosure. The features and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 flow diagram illustrating a method for publishing social network posts, according to an exemplary embodiment.

FIG. 2 is a flow diagram illustrating another method for publishing social network posts, according to an exemplary embodiment.

FIG. 3 is a flow diagram illustrating another method for publishing social network posts, according to an exemplary embodiment.

FIG. 4 is a flow diagram illustrating another method for processing posts, according to an exemplary embodiment.

FIG. 5 is a flow diagram illustrating another method for publishing social network posts, according to an exemplary embodiment.

FIG. 6 is a block diagram illustrating an apparatus for publishing social network posts, according to an exemplary embodiment.

FIG. 7 is a block diagram illustrating another apparatus for publishing social network posts, according to an exemplary embodiment.

FIG. 8 is a block diagram illustrating another apparatus for publishing social network posts, according to an exemplary embodiment.

FIG. 9 is a block diagram illustrating another apparatus for processing posts, according to an exemplary embodiment.

FIG. 10 is a block diagram illustrating another apparatus for publishing social network posts, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

In some embodiments, a first user, when posting on a social network, may tag or mention a second user, for example, by using “@” plus an identification, e.g., a name, of the second user. After the post is published, a server can notify the second user that he or she has been tagged or mentioned in the post and should check it out. Thus, the second user can easily keep track of the relevant messages.

However, in the prior art, whether to tag the second user is up to the first user. If the first user, though, wants the second user to view his/her post and does not think of using the “@” function or is not aware of such method, the first user can only passively hope that the post does not get buried by other contents and that the second user sees it, or notify the second user through other methods, e.g., texting a message.

Consistent with exemplary embodiments of this disclosure, a person drafting a post can notify other users by mentioning them in the posts as described below. The detailed description will also describe which user(s) to notify/tag. In this disclosure, the person drafting the post, or the “person,” may be interchangeable with a posting user, e.g., a user drafting a post to publish on a social network. Also, “tag” and “mention” may be used interchangeably.

### Exemplary Embodiment 1

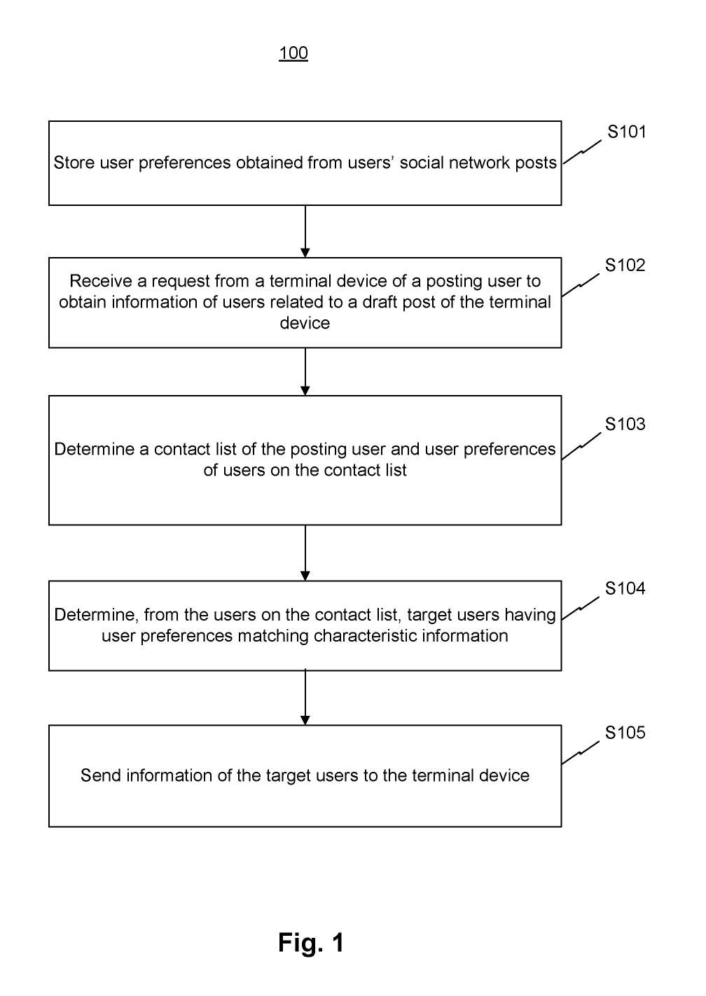

FIG. 1 is a flow diagram illustrating a method 100 for publishing social network posts, according to an exemplary embodiment. Method 100 comprises a number of steps, some of which may be optional.

At step 101, a server stores user preferences of social network posts. The user preferences may be obtained from users' social network posts. The posts can be any content/information published on a social network. The preferences can be stored in the server in a database format as illustrated in the following table.

| Serial No. | User ID | User preferences |
|---|---|---|
| 1 | User ID 1 | Preference 1 |
| 2 | User ID 2 | Preference 2 |
| . . . | . . . | . . . |

There can be many methods of determining the user preferences. For example, user actions (e.g., viewing, posting, commenting, or sharing contents) in a social network can be monitored/recorded, and user interests can be derived by analysis. In one example, if a user's posts often comprise food language or food pictures, an analysis may determine that the user is interested in food. Thus, one of the user preferences can be determined to be food. In another example, if another user often shares legal blogs, it can be determined that the one of the user preferences is legal matters.

A user can have more than one preference. Thus, the user preferences can be classified as information types and can be stored in the server in a database format as illustrated in the following table.

| Serial No. | User ID | User preferences (Information types) |
|---|---|---|
| 1 | User ID 1 | Information type 1, Information type 2 . . . |
| 2 | User ID 2 | Information type 3, Information type 4 . . . |
| . . . | . . . | . . . |

Based on the user preferences illustrated above, a list of users matching a draft post's content can be suggested to a posting user when the posting user is drafting the post, so that the posting user can easily tag/mention the users. The matching can be achieved by comparing the user preferences and the draft content.

In some embodiments, a posting user often has an option to publish a “present location” with a new post. If such option is used, a list of nearby locations can be suggested to be published with the post, when the posting user is drafting the post. When the post is published, the “present location” can be displayed with the post. The posting user may also be interested in other posts using location functions or posts indicating similar locations. Thus, location information can also be used as the preferences. When a list of users matching a draft post's content are to be suggested, the list can be determined with reference to the location information. The location information can be stored in a server in database format as illustrated in the following table.

| Serial No. | User ID | Location information |
|---|---|---|
| 1 | User ID 1 | Location 1, Location 2 . . . |
| 2 | User ID 2 | Location 3, Location 4 . . . |
| . . . | . . . | . . . |

In some embodiments, if a user, e.g., a posting user or a target user, uses the location function when publishing a post, a terminal device used by the user can accordingly determine the location of the user and send the user information with the location information to a server. The server can record the corresponding relation between the user and the location (user preference). The server can also derive location information corresponding to published posts based on message history saved in the server.

In some embodiments, the preferences may change with time. A user, e.g., a posting user or a target user, may pay attention to different contents at different times. The server may only save user preference during a recent period of time, for example, locations where posts were published within the most recent month. Thus, the server can suggest a list of users likely to be interested in the new post to the posting user drafting the new post, so that the posting user can mention/tag them or some of them in the new post.

At step 102, the server receives a request from a terminal device of a posting user, the request carrying identification information of the posting user related to a draft post including characteristic information. In some embodiments, the server receives a request from a terminal device of a posting user to obtain information of users related to a draft post of the terminal device, the request carrying identification information of the posting user drafting the post and characteristic information of the draft post.

In some embodiments, the server may have recorded preferences of multiple users. Based on the preferences and content of a new post, the server can recommend information, e.g., friends to tag/mention, to the posting user drafting the new post. For example, a posting user may attempt to post on a social network via an application installed on a terminal device. The terminal device may first receive an instruction to prepare to publish the post, e.g., when the posting user selects or operates to publish the post through an option provided on an interface of the application. Then, the posting user may add photos and/or texts to the post, and the draft post to be published now comprises the photos and/or the texts. When the posting user is inputting the draft post, the terminal device can analyze the draft post, including the photos and/or the description, to obtain characteristic information, e.g., user interests, information type, or location information described above. The terminal device may also send a request to the server to obtain information of users related to the draft post, the request carrying identification information of the posting user drafting the post and the characteristic information of the draft post.

The characteristic information of the draft post can be determined based on user preferences stored in a server database. For example, if post types are used to represent the user preference, the user terminal may derive a post type of a draft post to determine its characteristic information. The message type may be key words in draft content. In one example, if the terminal device determines that a draft post comprises menu items and restaurant names, it may determine the post type of the draft post to be food. In another example, if the draft post is a shared article, the terminal device may determine the post type of the draft post based on tags added by a posting user. The tags may be keywords of the article. In yet another example, the terminal device may determine the post type of the draft post based on comments (or keywords of comments) added by a posting user when the posting user shares an article. Thus, a word/relation database can be established based on keywords, such as menu items, restaurant names, etc., and their corresponding relations, to determine the post type of the draft post.

In some embodiments, the server can use location information as a user preference. The location information may be a location of a user, e.g., a posting user or a target user, when the user publishes a post. If the terminal device determines that the user has started a location identification function and has chosen a location name, the terminal device can determine the characteristic information of the post based on the location name.

In some embodiments, the request to obtain the information of users related to a draft post can be sent to the server when the terminal device determines the characteristic information of the draft post. For example, the terminal device can start analyzing an unfinished draft post when a posting user is still drafting. The terminal device can send the request to the server as soon as the terminal device determines the characteristic information of the draft post, which may occur before the posting user finishes drafting. For another example, sending the request can be triggered by the posting user. An option of determining the characteristic information and/or sending the request can be provided in an operation interface on the terminal device. When the terminal device determines that the option is selected, the terminal device may determine the characteristic information of the draft post and/or send the request to the server.

At step 103, the server determines a contact list of the posting user and user preferences of users on the contact list. In one example, after the server receives, from the terminal device, the request to obtain the information of users related to the draft post, the server determines a contact list of the posting user. The server may also determine preferences of users on the contact list based on the pre-stored preferences described above with reference to step 101.

At step 104, the server determines, from the users on the contact list, target users having user preferences matching the characteristic information. In some embodiments, after determining the contact list and the preferences of the users on the contact list, the server can compare the preferences with the characteristic information of the draft post and determine the target users whose preferences match the characteristic information. For example, the characteristic information may indicate that person A is at a restaurant, drafting a post to comment on a dish. And the restaurant may be among B's preferences, with B on A's contact list. B might have published similar posts at the restaurant. The server can determine that B may be interested in the post that A is drafting or the post may be valuable to B. Thus, the server can determine that B is a target user that can be tagged/mentioned in the draft post, i.e., a target user that can be recommended to A to “@”.

At step 105, the server sends information of the target users to the terminal device. The terminal device can suggest the target users to the posting user, so that the target users can be mentioned/tagged in the post through a preset mechanism. The server can send notifications of the post and mentioned users to respective terminal devices of the target users.

After determining the target users, the server can send information of the target users, e.g., user names, to the terminal device. Thus, the terminal device may suggest the target users to posting user, such that the posting user can mention the target user(s) or some of them in a new post, e.g., by using the “@” function. In one example, the terminal device, after determining that a posting user is drafting a post at a restaurant, may suggest to the person that “user A, B, and C have been to this restaurant before, do you want to @ them?” If the posting user accepts the suggestion and publishes the post, the terminal device can register the mentioned/tagged users when the posting user publishes the post and send information on the mentioned/tagged users to the server. After receiving the information on target users selected by the posting user to tag when the posting user publishes the post, the server can send notifications of the post to respective terminal devices of the selected target users, such that the target users can be promptly informed.

Consistent with exemplary embodiments of this disclosure, the server or the terminal device can store the user preferences of different users, so that when a posting user drafts a post, the server or the terminal device can determine if the draft post matches with any of the pre-stored user preferences. If yes, the server or the terminal device can suggest, to the posting user, users to tag/mention in the new post. Users who are tagged/mentioned can also be promptly notified of the new post by the server or the terminal device at the users' terminal devices and can easily find/view the new post.

In some embodiments, a non-transitory computer-readable medium stores one or more programs, the one or more programs comprising instructions which, when executed by a computer system including a server for publishing social network posts, cause the computer system to perform the methods/steps described above with reference to exemplary embodiment 1.

### Exemplary Embodiment 2

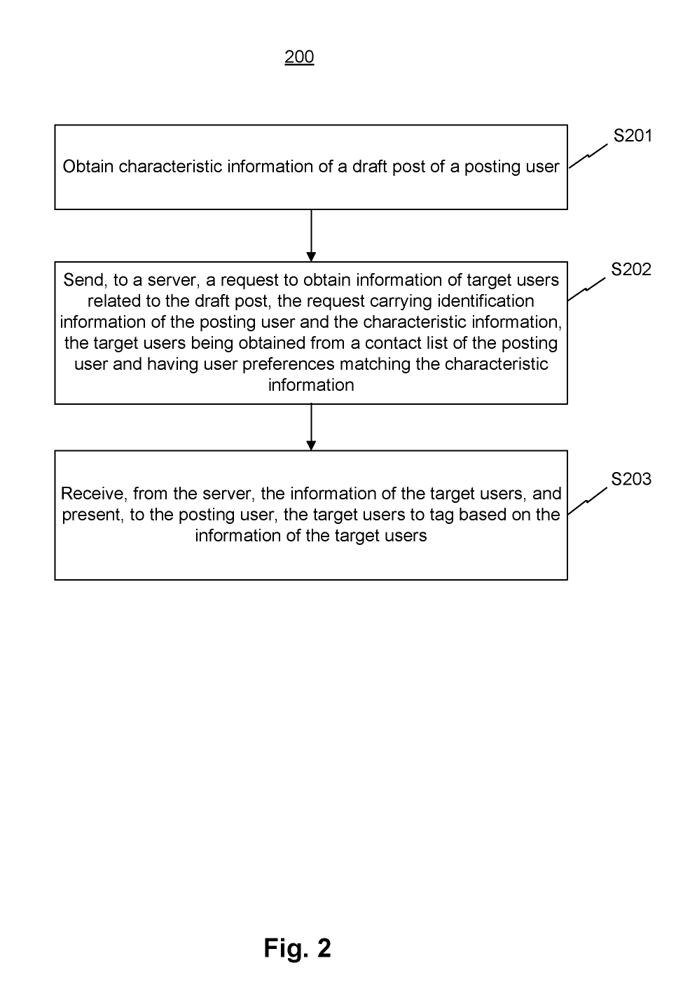

Exemplary embodiment 2 relates to exemplary embodiment 1 and can illustrate from a terminal device's perspective. FIG. 2 is a flow diagram illustrating another method 200 for publishing social network posts, according to an exemplary embodiment. Method 200 comprises a number of steps, some of which may be optional.

At step 201, the terminal device obtains characteristic information of a draft post of a posting user. Step 201 may be performed according to an instruction indicating that a posting user is drafting a post on the terminal device.

At step 202, the terminal device sends, to a server, a request to obtain information of target users related to the draft post, the request carrying identification information of the posting user and the characteristic information, the target users being obtained from a contact list of the posting user and having user preferences matching the characteristic information. Thus, the server can determine, based on pre-stored user preferences and from a contact list of the posting user, target users whose user preferences match with the characteristic information and send information of the target users to the terminal device.

At step 203, the terminal device receives the information of the target users and presents, to the posting user, the target users to tag/mention based on the information of the target users. The tag can be saved with the post, such that, once the post is published, the server can promptly notify the tagged users by sending the post to terminal devices of the tagged users and by indicating the tagging event.

In some embodiments, a non-transitory computer-readable storage medium stores one or more programs, the one or more programs comprising instructions which, when executed by a computer system including a terminal device for publishing social network posts, cause the computer system to perform the methods/steps described above with reference to exemplary embodiment 2.

### Exemplary Embodiment 3

Consistent with exemplary embodiments of this disclosure, user preferences can be saved in user-end terminal devices, e.g., mobile phones. The terminal device can suggest users to tag/mention based on the locally saved user preferences.

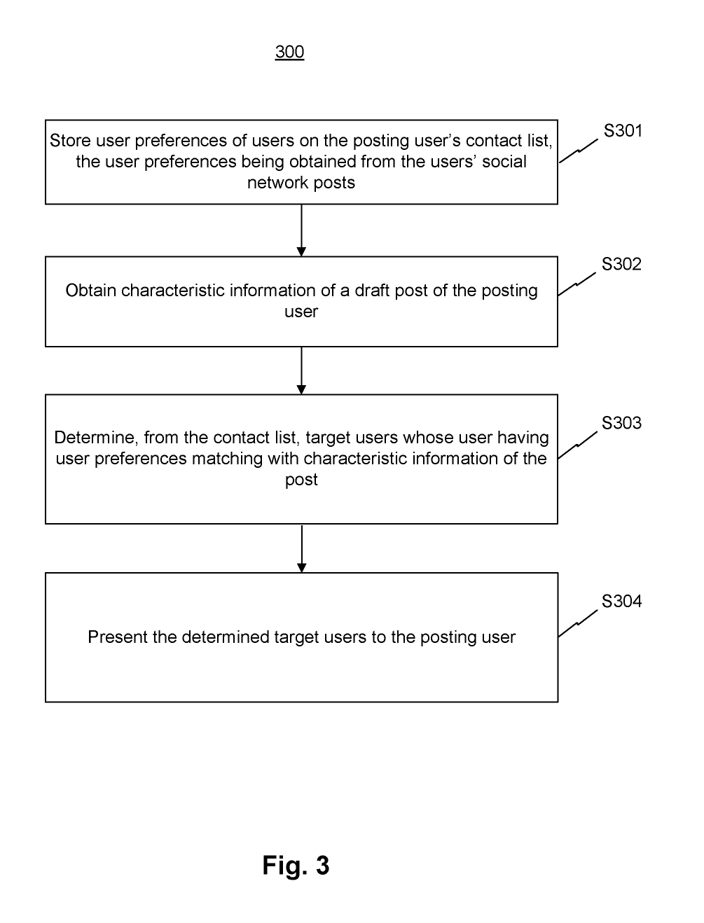

FIG. 3 is a flow diagram illustrating another method 300 for publishing social network posts, according to an exemplary embodiment. Method 300 comprises a number of steps, some of which may be optional.

At step 301, a terminal device, of a posting user, stores user preferences of users on the posting user's contact list, the user preferences being obtained from the users' social network posts. The storing may be storing locally in the terminal device.

The user preferences stored in the terminal device can be obtained from a server, for example, through communication from the server or requesting by the terminal device. The server may store user preferences of a large number of users, but a contact list of a person may comprise much fewer users and user preferences of people unknown to the posting user, i.e., those who are not on the person's contact list, may be irrelevant to the person. Thus, the person's terminal device may only store user preferences of users on a contact list of the posting user drafting posts on the terminal device, e.g., the owner of the terminal device. In one example, when a person logs in a server for the first time from a terminal device, the server can send pre-stored user preferences of users on the person's contact list to the terminal device, and the terminal device can locally store the user preferences.

At step 302, the terminal device obtains characteristic information of a draft post of a draft post of the posting user. Step 302 may be performed according to an instruction indicating that a posting user is drafting a post on the terminal device.

At step 303, the terminal device determines, from the contact list, target users having user preferences matching with characteristic information of the post.

At step 304, the terminal device presents the determined target users to the posting user, so that the target users can be mentioned/tagged in the post through a preset mechanism, and the server can send notifications of the post and mentioned/tagged users to respective terminal devices of the target users.

In some embodiments, a non-transitory computer-readable storage medium stores one or more programs, the one or more programs comprising instructions which, when executed by a computer system including a terminal device of a posting user for publishing social network posts, cause the computer system to perform the methods/steps described above with reference to exemplary embodiment 3.

### Exemplary Embodiment 4

Consistent with exemplary embodiments of this disclosure, user preferences can be based on location information and/or can be stored in a database format.

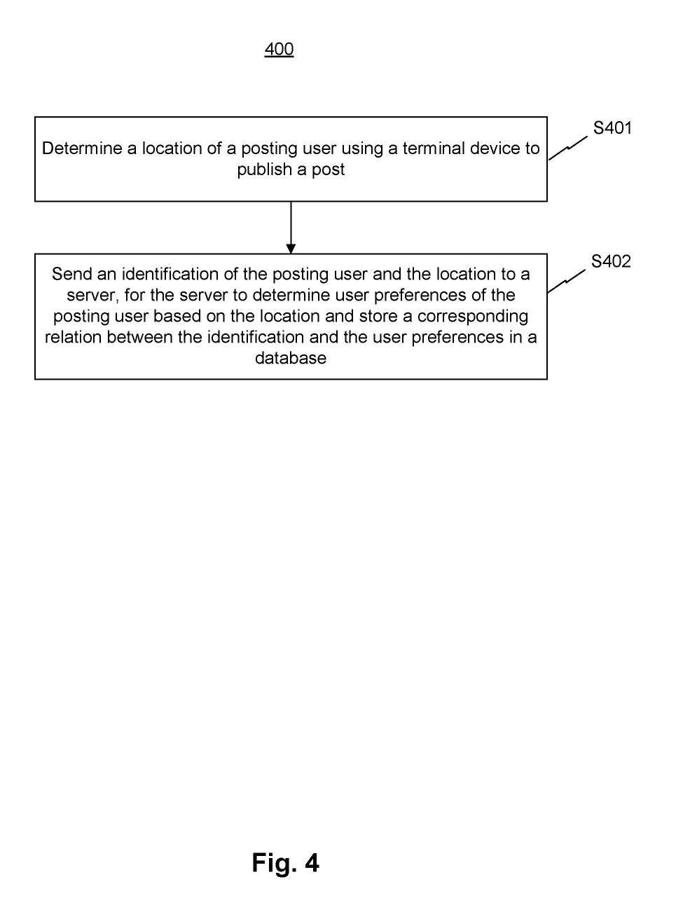

FIG. 4 is a flow diagram illustrating another method 400 for processing posts, according to an exemplary embodiment. Method 400 comprises a number of steps, some of which may be optional.

At step 401, a terminal device determines a location of a posting user using the terminal device to publish a post.

At step 402, the terminal device sends an identification of the posting user and the location to a server for the server to determine user preferences of the posting user based on the location and store a corresponding relation between the identification and the user preferences in a database.

In some embodiments, a non-transitory computer-readable storage medium stores one or more programs, the one or more programs comprising instructions which, when executed by a computer system including a terminal device for processing posts, cause the computer system to perform the methods/steps described above with reference to exemplary embodiment 4.

### Exemplary Embodiment 5

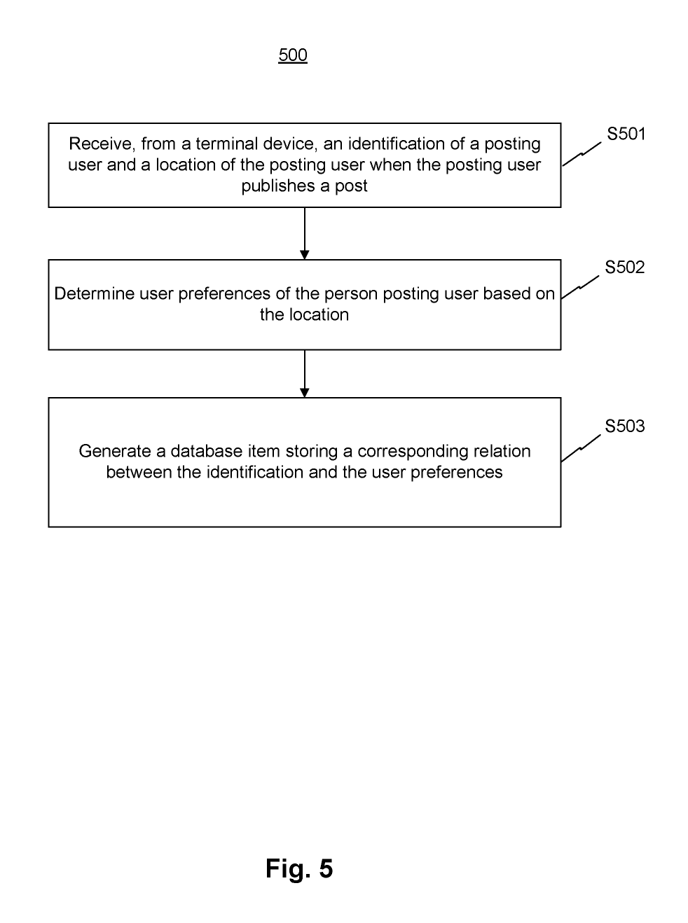

Consistent with exemplary embodiments of this disclosure, a server can establish a database for publishing social network posts. FIG. 5 is a flow diagram illustrating another method 500 for publishing social network posts, according to an exemplary embodiment. Method 500 comprises a number of steps, some of which may be optional.

At step 501, a server receives, from a terminal device, an identification of a posting user and a location of the posting user when the posting user publishes a post.

At step 502, the server determines user preferences of the posting user based on the location.

At step 503, the server generates a database item storing a corresponding relation between the identification and the user preferences.

In some embodiments, a non-transitory computer-readable storage medium stores one or more programs, the one or more programs comprising instructions which, when executed by a computer system including a server for publishing social network posts, cause the computer system to perform the methods/steps described above with reference to exemplary embodiment 5.

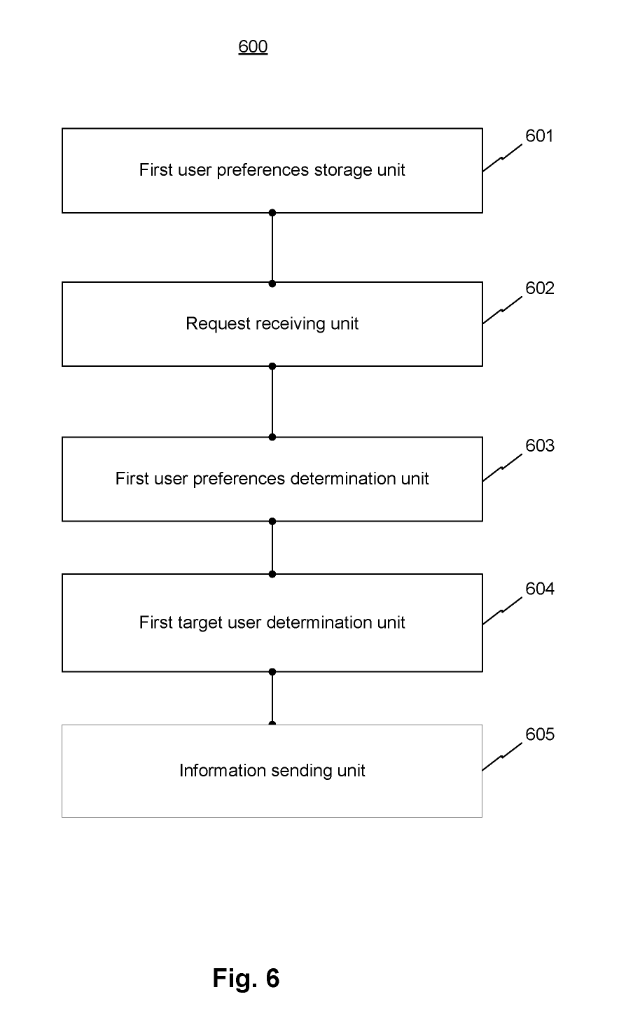

FIG. 6 is a block diagram illustrating an apparatus 600 for publishing social network posts, according to an exemplary embodiment. Apparatus 600 comprises a number of components, some of which may be optional.

First user preferences storage unit 601 may be configured to store user preferences of social network posts. The user preferences may be obtained from users' social network posts.

Request receiving unit 602 may be configured to receive a request from a terminal device of a posting user, the request carrying identification information of the posting user related to a draft post including characteristic information. In some embodiments, request receiving unit 602 may be configured to a request from a terminal device of a posting user to obtain information of users related to a draft post of the terminal device, the request carrying identification information of the posting user drafting the post and characteristic information of the draft post.

First user preferences determination unit 603 may be configured to determine a contact list of the posting user and user preferences of users on the contact list.

First target user determination unit 604 may be configured to determine, from the users on the contact list, target users having user preferences matching the characteristic information.

Information sending unit 605 may be configured to send information of the target users to the terminal device.

Apparatus 600 may be further configured to receive information on target users selected by the posting user to tag when the posting user publishes the post, and send notifications of the post to respective terminal devices of the selected target users.

In one example, the user preferences may be determined based on locations of the users when the users publish the social network posts, and the characteristic information may include a current location of the posting user.

In another example, the user preferences may be determined based on information types of posts published by the users on the social network, and the characteristic information may include an information type determined from the draft post.

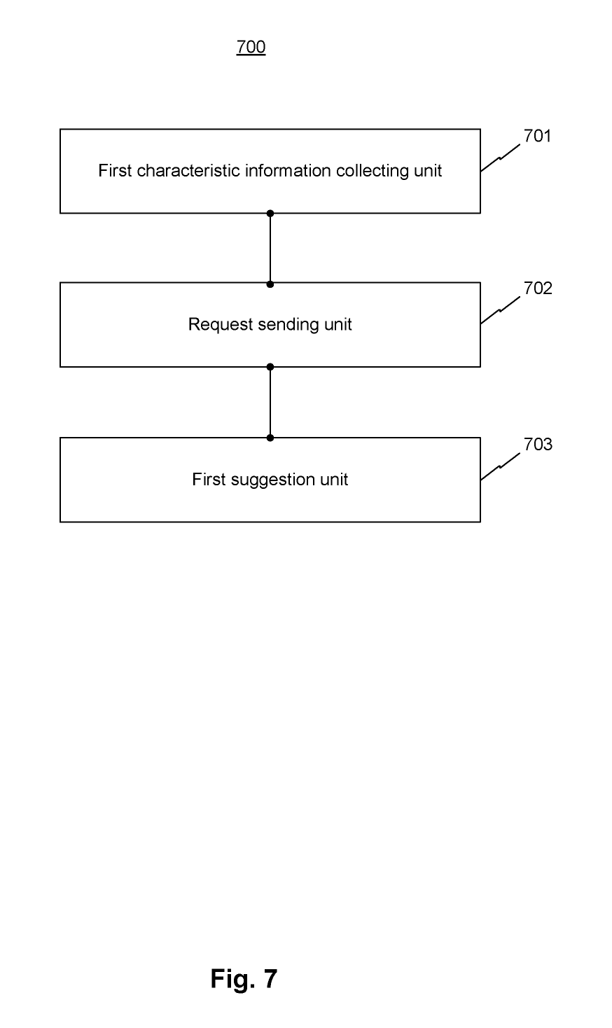

FIG. 7 is a block diagram illustrating another apparatus 700 for publishing social network posts, according to an exemplary embodiment. Apparatus 700 comprises a number of components, some of which may be optional.

First characteristic information collecting unit 701 may be configured to obtain characteristic information of a draft post of a posting user.

Request sending unit 702 may be configured to send, to a server, a request to obtain information of target users related to the draft post, the request carrying identification information of the posting user and the characteristic information, the target users being obtained from a contact list of the posting user and having user preferences matching the characteristic information

First suggestion unit 703 may be configured to receive, from the server, the information of the target users, and present, to the posting user, the target users to tag based on the information of the target users.

Apparatus 700 may be further configured to send information on target users, selected by the posting user to tag, to the server.

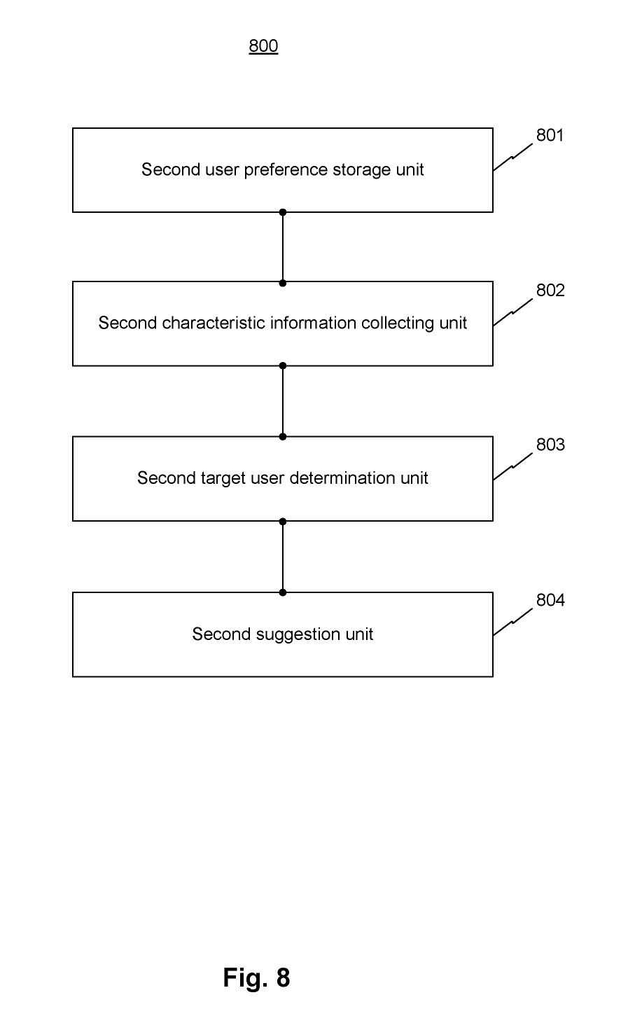

FIG. 8 is a block diagram illustrating another apparatus 800 for publishing social network posts, according to an exemplary embodiment. Apparatus 800 comprises a number of components, some of which may be optional.

Second user preference storage unit 801 may be configured to store user preferences of users on the posting user's contact list, the user preferences being obtained from the users' social network posts.

Second characteristic information collecting unit 802 may be configured to obtain characteristic information of a draft post of the posting user.

Second target user determination unit 803 may be configured to determine, from the contact list, target users having user preferences matching with characteristic information of the post.

Second suggestion unit 804 may be configured to present the determined target users to the posting user.

Apparatus 800 may be further configured to obtain, from a server, user preferences of users on a posting user's contact list.

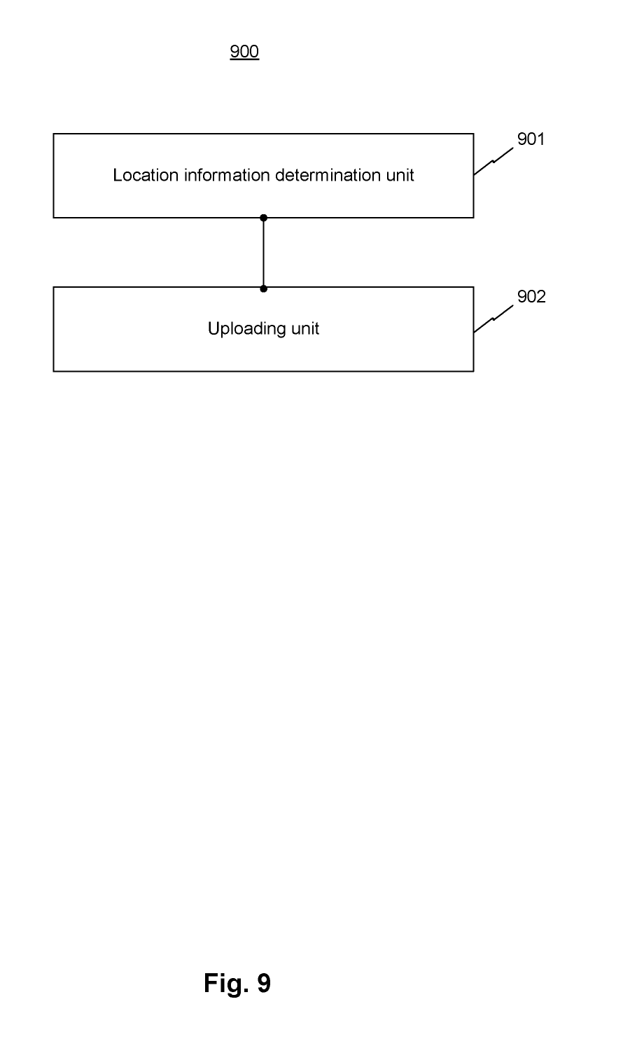

FIG. 9 is a block diagram illustrating another apparatus 900 for processing posts, according to an exemplary embodiment. Apparatus 900 comprises a number of components, some of which may be optional.

Location information determination unit 901 may be configured to determine a location of a posting user using the terminal device to publish a post.

Uploading unit 902 may be configured to send an identification of the posting user and the location to a server for the server to determine user preferences of the posting user based on the location and store a corresponding relation between the identification and the user preferences in a database.

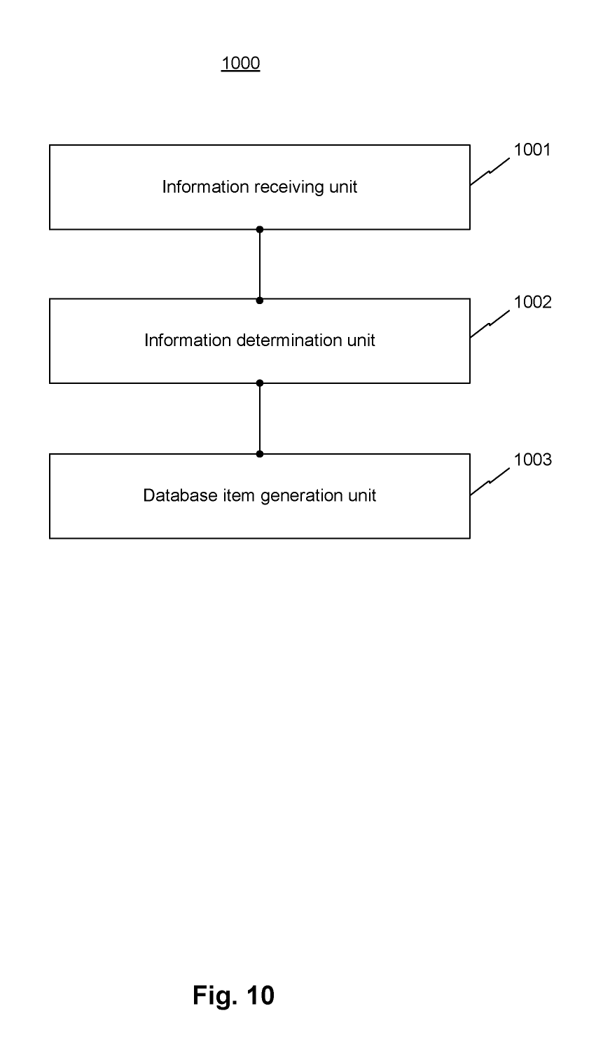

FIG. 10 is a block diagram illustrating another apparatus 1000 for publishing social network posts, according to an exemplary embodiment. Apparatus 1000 comprises a number of components, some of which may be optional.

Information receiving unit 1001 may be configured to receive, from a terminal device, an identification of a posting user and a location of the posting user when the posting user publishes a post.

Information determination unit 1002 may be configured to determine user preferences of the posting user based on the location.

Database item generation unit 1003 may be configured to generate a database item storing a corresponding relation between the identification and the user preferences.

Consistent with exemplary embodiments of this disclosure, the server or the terminal device can store the user preferences of different users, so that when a posting user drafts a post, the server or the terminal device can determine if the draft post matches with any of the pre-stored user preferences. If yes, the server or the terminal device can suggest, to the posting user, users to tag/mention in the new post. Users who are tagged/mentioned can also be promptly notified of the new post by the server at the users' terminal devices and can easily find/view the new post.

A person skilled in the art can further understand that various exemplary logic blocks, modules, circuits, and algorithm steps described with reference to the disclosure herein may be implemented as electronic hardware, computer software, or a combination of electronic hardware and computer software. For examples, the modules/units may be implemented by a processor executing software instructions stored in the computer readable storage medium.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment or a part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on functions involved. Each block in the block diagram and/or flowchart, and a combination of blocks in the block diagram and/or flowchart may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware. Furthermore, embodiments of the present disclosure may take the form of a computer program product embodied in one or more computer available storage media (including, but not limited to, a magnetic disk memory, a CD-ROM, an optical memory and so on) containing computer available program codes.

Embodiments of the present disclosure are described with reference to flow diagrams and/or block diagrams of methods, devices (systems) and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general-purpose computer, a special-purpose computer, an embedded processor, or other programmable data processing devices to produce a machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer readable memory that can direct a computer or other programmable data processing devices to function in a particular manner, such that the instructions stored in the computer readable memory produce a manufactured product including an instruction means which implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions which are executed on the computer or other programmable devices provide steps for implementing the functions specified in one or more flows in the flow diagrams and/or one or more blocks in the block diagrams. In a typical configuration, a computer device includes one or more Central Processing Units (CPUs), an input/output interface, a network interface and a memory. The memory may include forms of a volatile memory, a random access memory (RAM) and/or non-volatile memory and the like, such as a read-only memory (ROM) or a flash RAM in a computer readable storage medium. The memory is an example of the computer readable storage medium.

The computer readable storage medium refers to any type of physical memory on which information or data readable by a processor may be stored. Thus, a computer readable storage medium may store instructions for execution by one or more processors, including instructions for causing the processor(s) to perform steps or stages consistent with the embodiments described herein. The computer readable storage medium includes non-volatile and volatile media, removable and non-removable media, wherein information storage can be implemented with any method or technology. Information may be modules of computer readable instructions, data structures and programs or other data. Examples of a computer storage medium include, but are not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices or any other non-transmission media which may be used to store information capable of being accessed by a computer device. The computer readable storage medium is non-transitory, and does not include transitory media, such as modulated data signals and carrier waves.

The specification has described methods, apparatus, and systems for publishing social network posts. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for publishing social network posts, comprising:
storing, by a server, user preferences of social network posts;
receiving, by the server, a request from a terminal device of a posting user, the request carrying identification information of the posting user related to a draft post including characteristic information;
determining, by the server, a contact list of the posting user and user preferences of users on the contact list;
determining, by the server, from the users on the contact list, target users having user preferences matching the characteristic information; and
sending, by the server, information of the target users to the terminal device.

2. The method of claim 1, further comprising:
receiving, by the server, information on target users selected by the posting user to tag when the posting user publishes the post; and
sending, by the server, notifications of the post to respective terminal devices of the selected target users.

3. The method of claim 1, wherein:
the user preferences are determined based on locations of the user when the user publishes the social network posts; and
the characteristic information includes a current location of the posting user.

4. The method of claim 1, wherein:
the user preferences are determined based on information types of posts published by the user on the social network; and
the characteristic information includes an information type determined from the draft post, and
determining, by the server, from the users on the contact list, target users having user preferences matching the characteristic information when the user preferences and the characteristic belong to the same information type.

5. A method for publishing social network posts, comprising:
obtaining, by a terminal device, characteristic information of a draft post of a posting user;
sending, by the terminal device to a server, a request to obtain information of target users related to the draft post, the request carrying identification information of the posting user and the characteristic information, the target users being obtained from a contact list of the posting user and having user preferences matching the characteristic information;
receiving, by the terminal device from the server, the information of the target users; and
presenting, by the terminal device, to the posting user, the target users to tag based on the information of the target users.

6. The method of claim 5, further comprising:
sending, by the terminal device, information on target users selected by the posting user to tag, to the server.

7. The method of claim 5, wherein the user preferences are determined based on locations of the users when the users publish the social network posts.

8. The method of claim 5, wherein:
the user preferences are determined based on information types of social network posts published by the user on the social network,
the characteristic information includes an information type determined from the draft post, and
the target users are the users who have user preferences with information type matching the information type of the characteristic information.

9. A method for publishing social network posts, comprising:
storing, by a terminal device of a posting user, user preferences of users on the posting user's contact list;
obtaining, by the terminal device, characteristic information of a draft post of the posting user;
determining, by the terminal device and from the contact list, target users having user preferences matching with characteristic information of the post; and
presenting, by the terminal device, the determined target users to the posting user.

10. The method of claim 9, further comprising, before storing the user preferences of the users on the posting user's contact list:
obtaining, by a terminal device of a posting user and from a server, user preferences of users on the posting user's contact list.

11. The method of claim 9, wherein the user preferences are determined based on locations of the users when the users publish the social network posts.

12. The method of claim 9, wherein:
the user preferences are determined based on information types of social network posts published by the users on the social network; and
the characteristic information includes an information type determined from the draft post, and wherein
determining, by the terminal device and from the contact list, target users having user preferences matching with characteristic information of the post comprises determining, by the terminal device and from the contact list, target users having user preferences matching with characteristic information of the post when the user preferences and the characteristic belong to the same information type.

13. The method of claim 9, further comprising:
selecting, by the terminal device, some of the target users to tag when the terminal device publishes the post.

14. A method for processing posts, comprising:
determining, by a terminal device, a location of a posting user using the terminal device to publish a post; and
sending, by the terminal device, an identification of the posting user and the location to a server for the server to determine user preferences of the posting user based on the location and store a corresponding relation between the identification and the user preferences in a database.

15. A method for publishing social network posts, comprising:
receiving, by a server, from a terminal device, an identification of a posting user and a location of the posting user when the posting user publishes a post;
determining, by the server, user preferences of the posting user based on the location; and
generating, by the server, a database item storing a corresponding relation between the identification and the user preferences.

16. A non-transitory computer-readable storage medium storing one or more programs, the one or more programs comprising instructions which, when executed by a computer system including a server for publishing social network posts, cause the computer system to perform a method comprising:
storing user preferences obtained from users' social network posts;
receiving a request from a terminal device of a posting user to obtain information of users related to a draft post of the terminal device, the request carrying identification information of the posting user drafting the post and characteristic information of the draft post;
determining a contact list of the posting user and user preferences of users on the contact list;
determining from the users on the contact list, target users having user preferences matching the characteristic information; and
sending information of the target users to the terminal device.

17. The non-transitory computer-readable storage medium of claim 16, wherein the method further comprises:
receiving information on target users selected by the posting user to tag when the posting user publishes the post; and
sending notifications of the post to respective terminal devices of the selected target users.

18. The non-transitory computer-readable storage medium of claim 16, wherein:
the user preferences are determined based on locations of the users when the users publish the social network posts; and
the characteristic information includes a current location of the posting user.

19. The non-transitory computer-readable storage medium of claim 16, wherein:
the user preferences are determined based on information types of posts published by the users on the social network; and
the characteristic information includes an information type determined from the draft post.
